(19) United States
(12) Patent Application Publication
(10) Pub. No.: US 2021/0068441 A1
(43) Pub. Date: Mar. 11, 2021

(54) FOOD PROCESSING APPARATUS AND METHOD

(71) Applicant: Pasco Foods, Inc., Spicewood, TX (US)

(72) Inventor: Vincent Eugene BERNARD, Parkersburg, IA (US)

(21) Appl. No.: 16/938,574

(22) Filed: Jul. 24, 2020

Related U.S. Application Data
(60) Provisional application No. 62/878,134, filed on Jul. 24, 2019.

(51) Int. Cl. A23P 30/00; B65G 33/02

(52) U.S. Cl. CPC A23P 30/00; B65G 2201/0202; B65G 33/02

(57) ABSTRACT

A disclosed food processing assembly includes a plurality of food processing units. Each unit is configured to convey food product arriving at an ingress point to an egress point. The assembly includes rotary valves configured to transfer food product from the egress point of one unit to the ingress point of a subsequent unit while maintaining environmental isolation between the two units. A programmable electronic controller is configured to monitor environmental parameters within each unit and to generate control signals provided to various resources to maintain environmental parameters within each unit at a distinct set of value. The resources may include air compressors, steam generators, vacuum pumps, and the like. In this manner, the assembly enables a multi-step food process to proceed essentially continuously with little or no delay between sequential process steps despite with each step being associated with a distinct set of time, temperature, pressure, and humidity values.

### FIELD OF INVENTION

Disclosed subject matter is in the field of food processing and, more particularly, machines, assemblies, apparatus, and processes for automated food processing.

### BACKGROUND

Conventional food processing is typically performed with a batch system that includes a single pressure vessel. Performing a multi-step food processing method with a batch system may include appreciable quantities of transitional time during which environmental conditions, such as temperature and pressure, within the pressure vessel are ramped or otherwise transitioned from a first set of conditions considered suitable or advantageous for a first process or treatment to a second set of conditions considered suitable or advantageous for a second process or treatment.

### SUMMARY

The following detailed description and the accompanying drawings disclose a food processing assembly and a food processing method that employ a specially configured combination of two or more food processing units and a two or more valves suitable for transferring food product from one food processing unit to another food processing unit while maintaining thermal and pneumatic isolation between pressure vessels within each of the adjoining food processing units. By environmentally isolating each food processing unit pressure vessel while still permitting direct transfer of food product from one food processing unit to the next, food processing assemblies disclosed herein support multi-stage food processes that incur little or no inter process delay time. Each stage in the process is performed in the ambient conditions considered most effective or advantageous for the applicable process. Differences between environmental parameters including temperature, pressure, and humidity, between any two adjacent or sequentially arranged pressure vessels will not appreciably increase the overall duration of the overall process because pressure and temperature ramping is unnecessary.

Each food processing unit is configured to convey food product from an ingress point to an egress point. Food product may be conveyed by any suitable type of conveyor including, as non-limiting examples, a screw flight conveyor, a mesh conveyor, a vibratory conveyor, or any other suitable type of conveyor. An electrical or hydraulic motor may drive each type of conveyor.

In at least one embodiment, the assembly includes various sensors for indicating environmental conditions within each pressure vessel and an electronic controller configured to receive the sensor inputs. The controller may be programmed to monitor the sensor inputs and any other inputs providing information indicative of one or more parameters associated with the process. In addition, the controller may be programmed or otherwise configured to generate control signals to control the operation of various machine resources associated with the food processing units. These resources may include one or more compressors for generating and delivering compressed gas into one or more of the pressure vessels, one or more vacuum pumps for generating a desired ambient pressure within one or more of the pressure vessels, and one or more steam generators for generating and delivering steam or another suitable aqueous medium to one or more of the pressure vessels.

The one or more compressors may include compressors for generating a compressible fluid such as compressed air, compressed nitrogen (N₂), compressed carbon dioxide (CO₂), or any other composition or element suitable for use in food processing applications. In at least one embodiment, the compressed gas generators include at least one hot compressor configured to produce hot gas, i.e., compressed gas at a hot temperature, and at least one cold compressor configured to produce cold gas, i.e., compressed gas at a cold temperature. In these embodiments, the controller may be configured to control the hot compressor and the cold compressor to maintain the temperature of any particular pressure vessel at a desired temperature.

The food processing assembly may further include a matrix of control valves coupling the various machine resources for providing compressed gas, steam, and vacuum to the food processing units. In these embodiments, the controller may be programmed or otherwise configured to generate control signals for each of the one or more control valves. In addition, the assembly may include one or more release valves coupling a corresponding pressure vessel to atmosphere and the controller may be configured to activate or otherwise control the relief valves, for example, in response to detecting an unintended or undesirable combination of parameters within one or more of the pressure vessels.

The controller may be further configured to operate a rotary valve at an ingress point of the first food processing unit to control a rate at which food product is introduced into the assembly. Similarly, the controller may be configured to generate control signals for drive motors associated the conveyors within each of the food processing units. In these embodiments, the rate at which food product is introduced into the assembly and the speed at which food product is conveyed within any of the pressure vessels may be determined by the controller and maintained via control signals provided to each of the drive motors. Drive motor speeds and the rate of food product intake may be determined in accordance with the dimensions of each food processing unit and the desired duration of each food processing stage to maintain a quantity or density of food product within each of the food processing units in compliance with one or more criteria or thresholds. For example, the rate of food intake may be determined in accordance with the longest process or treatment to prevent unwanted accumulation of food product within each food processing unit. To facilitate this type of control, the assembly may include one or more sensors in each of the food processing units for monitoring a mass or density of food product within each pressure vessel.

In another aspect, a food processing method disclosed in the following detailed description and the accompanying drawings includes introducing food product to an ingress point of a first food processing unit of a disclosed food processing assembly and conveying food product from the ingress point to an egress point, which is coupled to an ingress point of a second food processing unit by a rotary valve. The method further includes transferring food product at the egress point of the first food processing unit to the ingress point of the second food processing unit while maintaining environmental parameters within each pressure vessel. The method further includes monitoring, by the electronic controller or another suitable device, environmental parameters within the pressure vessel of each food processing unit and maintaining the environmental parameters in accordance with a set of values suitable for the food processing treatment assigned to each food processing unit. The controller may maintain the environment within each pressure vessel by generating and maintaining one or more control signals to control resources such as gas compressors, vacuum pumps, and steam generators coupled to the food processing units. The control signals may include signals to power resources on and off as well as signals to operate control valves coupling each pressure vessel to one or more of the machine resources.

### BRIEF DESCRIPTION OF THE DRAWINGS

The following figures are included to illustrate aspects and exemplary implementations of disclosed subject matter. Those of ordinary skill in the field of food processing equipment and processes will recognize that disclosed subject matter may be readily employed in implementations that may not be illustrated or expressly described herein.

FIG. 1 illustrates a side elevation view of a food processing assembly including a plurality of food processing units and a plurality of rotary valves coupling the food processing units;

FIG. 2 illustrates a side view of a food processing unit suitable for use in the food processing assembly of FIG. 1;

FIG. 3 illustrates a side view of another food processing unit suitable for use in the food processing assembly of FIG. 1;

FIG. 4 illustrates a sectional view of a rotary valve suitable for use in a food processing assembly; and

FIG. 5 illustrates a sectional view of an exemplary food processing unit and pressure vessel.

FIG. 6 illustrates a schematic of elements for controlling the environment within a pressure vessel of a food processing unit;

Throughout this disclosure like reference numerals refer to like elements unless expressly indicated to the contrary. In addition, a reference numeral without hyphenation may indicate an element generically or a plurality of elements collectively while a specific instance of an element may be identified by a hyphenated reference. For example: . . . the widgets 99 illustrated in FIG. X include a first widget 99-1 wherein each widget 99 may include . . . .

### DETAILED DESCRIPTION

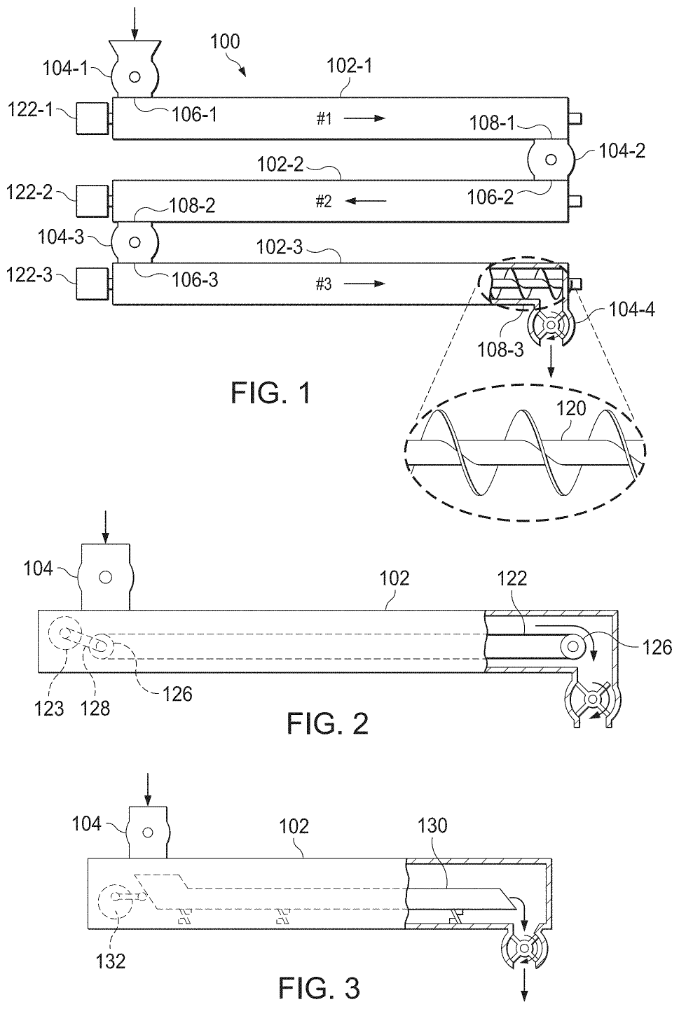

Referring to FIG. 1, a continuous process apparatus, referred to herein as food processing assembly 100, is illustrated. The illustrated food processing assembly 100 is a controlled pressure steamed system that includes a plurality of individual food processing units 102, each of which includes a corresponding pressure vessel (not explicitly depicted in FIG. 1). Unlike single-vessels systems typically used for continuous process applications, food processing assembly 100 beneficially employs a plurality of independent and pre-conditioned pressure vessels in combination with a set of rotary valves 104 that maintain isolation between the pressure vessels in adjacent food processing units to improve efficiency by eliminating or significantly reducing delay associated with temperature and pressure ramping and thereby reducing the total process time. Processes that include two or more process steps, each requiring a distinct set of environmental parameters, may impose a ramping overhead approaching or exceeding 50% of the total process time when executed in a single-vessel system. Food processing assembly 100 eliminates all or substantially all ramping overhead in an automated continuous process that requires little or no labor.

Food processing assembly 100 is suitable for processing substantially all varieties of fruits, vegetables, meat, poultry and seafood. In addition, food processing assembly 100 supports a wide variety of food processing treatments such as blanching, cooking, and texture modifying treatments. Each hermetically sealed and thermally insulated food processing unit 102 can be programmed to provide a desired environmental state and a desired process duration.

The food processing assembly 100 illustrated in FIG. 1 includes three food processing units 102. Each food processing unit 102 is independently programmable to provide an environment suitable for a particular process or treatment. Although the food processing assembly 100 illustrated in FIG. 1 includes three food processing units, it will readily appreciated that food processing assembly 100 could include more or fewer food processing units 102.

The food processing assembly 100 illustrated in FIG. 1 further includes a group of rotary valves 104 (104-1, 104-2, 104-3, and 104-4). The rotary valves 104 illustrated in FIG. 1 include one rotary valve 104-1 coupled to an ingress point 106-1 of the first food processing unit 102-1, one rotary valve coupled to an egress point 108-4 of the last food processing unit 102-3 and rotary valves 104-2, 104-3 coupled between each pair of adjacent food processing units 102. Thus, rotary valve 104-2 couples an egress point 108-1 of first processing unit 102-1 to an ingress point 106-2 of second food processing unit 104-2 and rotary valve 104-3 couples an egress point 108-2 of second food processing unit 102-2 to an ingress point 106-3 of third food processing unit 102-3. Each ingress point 106 and egress point 108 may include or define an aperture that is sized and shaped to accept one end of a rotary valve 104.

The food processing units illustrated in FIG. 1 are arranged in a vertical configuration wherein first processing unit 102-1 is positioned above second food processing unit 102-2 and second food processing unit 102-2 is positioned above third food processing unit 102-3. In this vertical configuration, each ingress point 106 is located in an upper surface at one end of food processing unit 102 while each egress point 108 is located in a lower surface of the other end of food processing unit 102. In other embodiments of food processing assembly 100, the food processing units 102 may be positioned differently with respect to one another and ingress points 106 and egress points 108 may be located in different positions within each food processing unit 102. As a non-limiting example, where vertical space may be limited, food processing units 102 may be arranged in a horizontal configuration, with each of food processing unit 102 located in a single, horizontally-oriented plane. In these embodiments, ingress points 106 and egress points 108 may be located in opposing ends of food processing unit 102. Other embodiments of food processing assembly 100 may feature still other configurations of food processing units 102.

Returning to the food processing assembly 100 illustrated in FIG. 1, food product to be processed is provided at an open end of the first rotary valve 104-1, which transfers the incoming food product into first processing unit 102-1 through ingress point 106-1. Rotary valves 104, are configured to assure temperature and pressure isolation between adjacent food processing units 102 and between each food processing unit and atmosphere. Food product entering first food processing unit 102-1 is conveyed from ingress point 106-1 to egress point 108-1 by a suitable conveyor or conveying mechanism. The processing unit 102-3 illustrated in FIG. 1 includes a screw flight conveyor 120 driven by an electric or hydraulic drive motor 122. Drives motors 122 may be implemented with adjustable and programmable drive speeds to set and control the speed of the applicable conveyor and thereby set and control the duration of the process or treatment performed by the applicable food processing unit 102.

Food product is conveyed through first food processing unit 102-1 to egress point 108-1, where the food product passes through rotary valve 104-2 into second food processing unit 102-2 via ingress point 106-2. Second food processing unit 102-2 conveys food product from ingress point 106-2 to egress point 108-2. In the configuration illustrated in FIG. 1, the direction of food product movement alternates between left-to-right and right-to-left when the food product transitions from one food processing unit 102 to the next. Second food processing unit 102-2 is programmed and pre-conditioned to perform a second process or treatment as food product is conveyed from ingress point 106-2 to egress point 108-2. At egress point 108-2, food product is transferred to an ingress point 106-3 of third food processing unit 102-3 via rotary valve 104-3. Third food processing unit 102-3 performs a third and, in the illustrated example, final process or treatment while conveying food product from ingress point 106-3 to egress point 108-3, where the food product exits food processing assembly 100 via the fourth and final rotary valve 104-4. Having completed all three processes or treatments, finished food product passing through rotary valve 104-4 may be further processed and/or packaged for distribution and sale.

FIG. 2 illustrates a food processing unit 102 that uses a second type of conveyor to convey food product from one end of the unit to the other. Specifically, instead of the screw flight conveyer 120 illustrated in FIG. 1, the food processing unit 102 depicted in FIG. 2 includes a mesh conveyor 122 powered by an electric or hydraulic adjustable speed driving pulley 123 coupled to a driven pulley 126 via belt 128.

FIG. 3 illustrates a food processing unit 102 that includes a vibratory conveyor 130 with a variable amplitude (speed) motor 132 designed to vibrate conveyor 130 to convey food product through the treatment zone. In at least some embodiments, the conveyor 130 may be oriented at a small angle to enable gravity to assist the conveyance of food product.

All food product units and their corresponding pressure vessels and any contact parts are fabricated with materials approved for food contact including, where appropriate, stainless steel, copper, aluminum, or another suitable material.

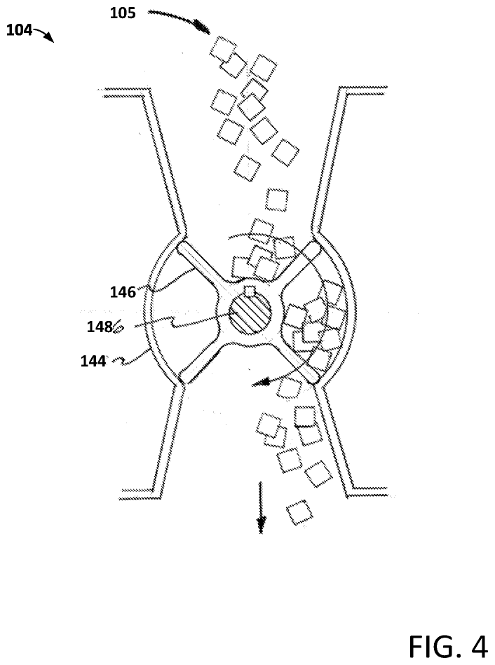

FIG. 4 is a cross sectional and detailed view of a rotary valve 104. Rotary valve 104 is configured to transfer food product 105 directly from one pressure vessel to another while maintaining thermal and hermetic isolation between the pressure vessels such that each pressure vessel may maintain its own settings for pressure, heat, etc.

Outer structures 144 of the illustrated rotary valve 104 may be fabricated from stainless steel and reinforced to withstand pressure, vacuum and temperature differentials between adjoining pressure vessels. A rotary vane 146 is designed to define pockets sufficient to hermetically seal and thermally isolate the two adjoining pressure vessels while continuing to transfer food product. Any pressure or thermal differentials between the vessels that occur will be detected by instrumentation and compensated. The rotary vane 146 may be constructed of high molecular weight polyethylene or other suitable material to offer low friction while maintaining a positive seal. The rotary vane 146 may be driven by a shaft 148 driven by an electric or hydraulic variable speed power unit (not depicted in FIG. 4).

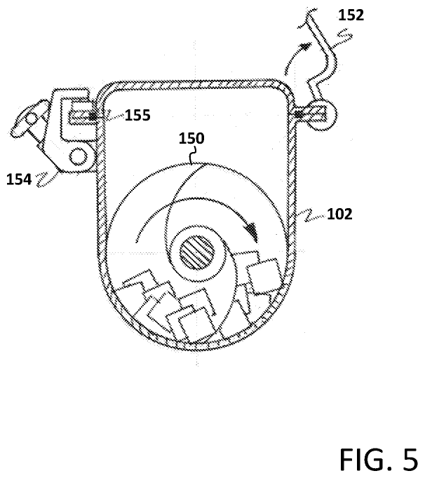

FIG. 5 depicts a sectional view of an exemplary food processing unit 102 and its corresponding pressure vessel 150. In the illustrated embodiment, food processing unit 102 includes access doors 152 for cleaning and maintenance. Pressure vessels 150 and access doors 152 are suitably re-enforced to withstand all pressures and vacuums applied through the process. Clamping 154 and rubber sealing gaskets 155 assure a complete hermetic seal.

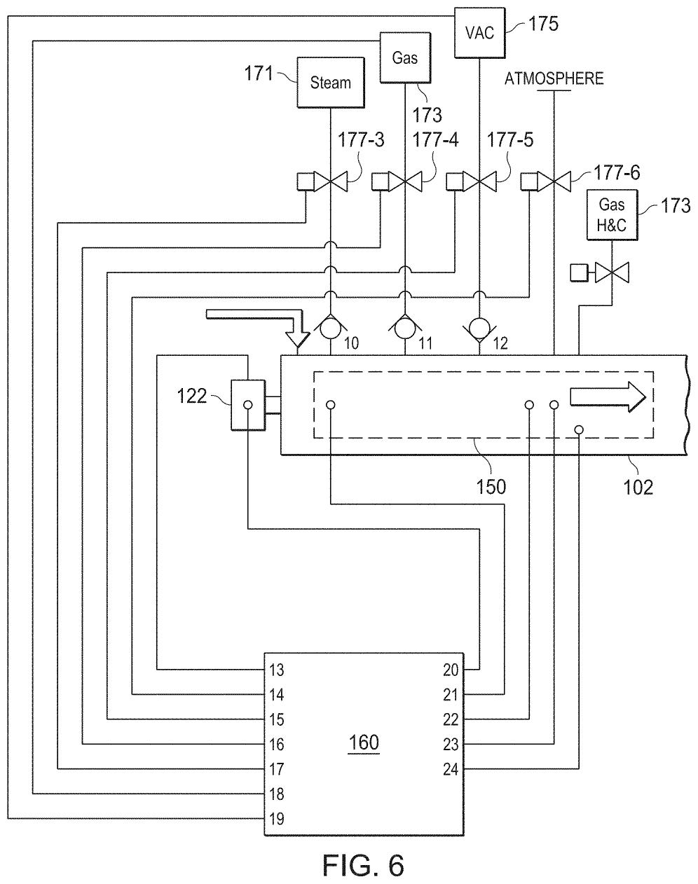

FIG. 6 depicts a control schematic utilized to program each food processing unit to perform an individual process or treatment. A programmable controller 160 is configured to monitor conditions within each pressure vessel 150 and to generate control signals to operate compressors, pumps, generators, and so forth as well as a matrix of associated control valves and check valves to provide and maintain desired conditions within each pressure vessel.

The programmable controller 160 illustrated in FIG. 6 is configured to receive as inputs signals generated by one or more sensors or other devices. These inputs may include, as non-limiting examples:

inputs 21 indicative of: the internal temperature of each pressure vessel 150;

inputs 22 indicative of the internal pressure or vacuum within each pressure vessel 150;

inputs 20 indicative of tachometer feedback from drive motor 122;

inputs 23 indicative of relative humidity in each pressure vessel 150; and

inputs 24 indicative of a mass or density of food product within each pressure vessel 150.

The depicted controller 160 is further configured to generate control signal outputs to operate and control machines and valves including one or more steam generators 171, one or more gas compressors 173, one or more vacuum pumps 175, and a matrix of control valves 177 coupling the compressors, generators, and pumps to each of pressure vessels.

The control signal outputs illustrated in FIG. 6 include:

motor control speed outputs 13 provided to each drive motor;

outputs 14 to open or close one or more atmospheric dump valves 177-6;

outputs 15 to open or close one or more vacuum valves 177-5;

outputs 16 to open or close air valves 177-4;

outputs 17 to open or close steam valves 177-3;

outputs 18 to power gas compressor(s) 173 on and off; and

outputs 19 to power vacuum pump(s) 175 on/off;

FIG. 6 illustrates check valves 10, 11 and 12 utilized to prevent pressure or vacuum backflow. Steam generated by steam generator 171 may be used for the purpose of blanching or heating of the interior of the pressure vessel 150 although the use of hot or cold compressed gas (e.g., air, N2, CO2, etc.) provided by gas compressor 173 may be preferable in at least some applications. Compressed gas provided by a gas compressor 177 may be superheated using electrical heat coil in the conduit or cooled using a suitable refrigerant such as ammonia or Freon.

In the preceding description, the figures and the accompanying description represent exemplary embodiments whereas the disclosed subject matter is intended to encompass all embodiments, including embodiments not specifically depicted, of disclosed subject matter.

What is claimed is:

1. A food processing assembly, comprising:
a plurality of food processing units, wherein each food processing unit comprises a pressure vessel and includes an ingress point, an egress point, wherein each food processing unit is configured to convey food product arriving at the ingress point to the egress point;
a plurality of food product valves including a first food product valve coupling an egress point of a first food processing unit to an ingress point of a second product unit, wherein the first food product valve is configured to transfer food product from the egress point of the first food processing unit to the ingress point of the second food processing unit provide maintaining environmental isolation between the first and second food processing units; and
a controller configured to receive information indicative of environmental parameters within the first and second food processing units and further configured to maintain environmental parameters within the first and second food processing units at distinct values.

2. The food processing assembly of claim 1, wherein the first food product valve comprises a rotary valve.

3. The food processing assembly of claim 1, further comprising one or more process sensors including one or more environmental sensors configured to provide the information indicative of environmental parameters within the first and second food processing units.

4. The food processing assembly of claim 3, wherein the environmental sensors include temperature sensors, pressure sensors, and humidity sensors.

5. The food processing assembly of claim 1, wherein the controller is configured to generate and maintain one or more control signals to control one or more resources coupled to one or more of the food processing units, wherein the one or more resources are selected from a group of resources comprising: a steam generator, one or more air compressors, and one or more vacuum pumps.

6. The food processing assembly of claim 5, further comprising one or more control valves coupling one or more of the resources to one or more of the food processing units, wherein the controller is configured to generate control signals for each of the one or more control valves, wherein the one or more control valves include:
one or more steam valves coupling the steam generator to one or more of the food processing units;
one or more pressure valves coupling the one or more vacuum pumps to one or more of the food processing units; and
one or more air valves coupling the one or more air compressors to one or more of the food processing units.

7. The food processing assembly of claim 6, wherein the one or more air compressors include a first air compressor configured to provide compressed air at a cold air temperature and a second air compressor configured to provide compressed air at a hot air temperature.

8. The food processing assembly of claim 7, wherein the first and second food processing units are each coupled to a corresponding pair of air valves, wherein each pair of air valves includes a cold air valve coupled to the cold air compressor and a hot air valve coupled to the hot air compressor, wherein the controller is enabled to:
maintain the first food processing unit at first ambient temperature within a temperature range between the cold air temperature and the hot air temperature; and
maintain the second food processing unit at second ambient temperature, distinct from the first ambient temperature, within a temperature range between the cold air temperature and the hot air temperature.

9. The food processing assembly of claim 6, wherein the one or more control valves include one or more release valves coupled to an atmospheric environment and wherein each of the food processing units is coupled to a corresponding one of the release valves.

10. The food processing assembly of claim 1, wherein one or more of the food processing units includes a conveyor and a drive motor configured to operate the conveyor, wherein the controller is configured to generate a drive motor control signal for each drive motor to control a speed of the drive motor and to thereby control a process duration, wherein the process duration comprises a duration required for food product to be conveyed from the ingress point to the egress point.

11. The food processing assembly of claim 10, wherein the conveyor is of a conveyor type selected from a group of conveyor types comprising: a screw flight conveyor, a mesh belt conveyor, and vibratory conveyors.

12. The food processing assembly of claim 10, wherein the controlled is configured to control a rate at which food product is introduced to an ingress point of the first food processing unit in accordance with a duration of the longest process interval.

13. The food processing assembly of claim 12, wherein the one or more process sensor include one or more mass sensors, wherein each mass sensor is configured to indicate a mass of food product within a corresponding one of the food processing units and wherein the controller is configured to monitor the mass of food product within each of the food processing units with respect to desired thresholds.

14. A food processing method, comprising:
introducing food product to an ingress point of a first food processing unit of a food processing assembly comprising a plurality of food processing units, wherein each food processing unit comprises a pressure vessel and includes an ingress point, an egress point, and wherein each food processing unit is configured to convey food product arriving at the ingress point to the egress point and wherein the egress point of the first food processing unit is coupled to an ingress point of a second food processing unit;
transferring food product at the egress point of the first food processing unit to the ingress point of the second food processing unit while maintaining environmental isolation between the first food processing unit and the second food processing unit;
monitoring environmental parameters within the first food processing unit and the second processing unit;
maintaining the environmental parameters with the first processing unit in accordance with a first set of environmental values suitable for a first food processing operation; and
maintaining the environmental parameters with the second processing unit in accordance with a second set of environmental values suitable for a second food processing operation.

15. The food processing method of claim 14, wherein the first set of environmental values includes a first set of temperature, pressure, and humidity values and wherein the second set of environmental values includes a second set of temperature, pressure, and humidity values that differ in one or more respects from the first set of environmental values.

16. The food processing method of claim 14, further comprising:
generating and maintaining one or more control signals to control one or more resources coupled to one or more of the food processing units, wherein the one or more resources are selected from a group of resources comprising: a steam generator, one or more air compressors, and one or more vacuum pumps.

17. The food processing method of claim 16, further comprising:
generating control signals for one or more control valves coupling one or more of the resources to one or more of the food processing units, wherein the one or more control valves include:
one or more steam valves coupling the steam generator to one or more of the food processing units;
one or more pressure valves coupling the one or more vacuum pumps to one or more of the food processing units; and
one or more air valves coupling the one or more air compressors to one or more of the food processing units.

18. The food processing method of claim 17, wherein the one or more air compressors include a first air compressor configured to provide compressed air at a cold air temperature and a second air compressor configured to provide compressed air at a hot air temperature.

19. The food processing method of claim 18, wherein the first and second food processing units are each coupled to a corresponding pair of air valves, wherein each pair of air valves includes a cold air valve coupled to the cold air compressor and a hot air valve coupled to the hot air compressor, wherein the method includes:
maintaining the first food processing unit at first ambient temperature within a temperature range between the cold air temperature and the hot air temperature; and
maintaining the second food processing unit at second ambient temperature, distinct from the first ambient temperature, within a temperature range between the cold air temperature and the hot air temperature.

20. The food processing method of claim 19, wherein one or more of the food processing units includes a conveyor and a drive motor configured to operate the conveyor, wherein the method includes:
generating a drive motor control signal for each drive motor to control a speed of the drive motor and to thereby control a process duration, wherein the process duration comprises a duration required for food product to be conveyed from the ingress point to the egress point.
